(19) United States
(12) Patent Application Publication
(10) Pub. No.: US 2018/0098345 A1
(43) Pub. Date: Apr. 5, 2018

(54) DYNAMIC CODEBOOK ADAPTATION FOR ENHANCED CARRIER AGGREGATION

(71) Applicant: Nokia Technologies Oy, Espoo (FI)

(72) Inventors: Esa Tiirola, Kempele (FI); Kari Hooli, Oulu (FI); Timo Lunttila, Espoo (FI); Klaus Hugl, Wien (AT)

(21) Appl. No.: 15/564,051

(22) PCT Filed: Apr. 5, 2016
(86) PCT No.: PCT/IB2016/051928

§ 371 Date: Oct. 3, 2017

Related U.S. Application Data
(60) Provisional application No. 62/145,319, filed on Apr. 9, 2015.

(51) Int. Cl. H04W 72/12; H04L 5/00; H04L 1/18; H04B 7/0456

(52) U.S. Cl. CPC H04W 72/1289; H04L 5/0055; H04L 5/0098; H04L 5/0039; H04L 1/1861; H04B 7/0456; H04L 5/0023; H04L 5/001

(57) ABSTRACT

A method and apparatus may include determining, by a network node, a plurality of carrier groups. The method may also configuring a user equipment to use the plurality of carrier groups. The method may also include incrementing a downlink assignment index from one scheduled carrier group to another. The downlink assignment index is included with each downlink assignment of a plurality of downlink assignments. The method may also include transmitting the plurality of downlink assignments to the user equipment. Each of the plurality of downlink assignments schedules a downlink channel on a carrier belonging to one of the plurality of carrier groups.

### BACKGROUND

### Field

Embodiments of the present invention relate to implementing dynamic codebook adaptation for enhanced carrier aggregation.

### Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include determining, by a network node, a plurality of carrier groups. The method may also include configuring a user equipment to use the plurality of carrier groups. The method may also include incrementing a downlink assignment index from one scheduled carrier group to another. The downlink assignment index is included with each downlink assignment of a plurality of downlink assignments. The method may also include transmitting the plurality of downlink assignments to the user equipment. Each of the plurality of downlink assignments schedules a downlink channel on a carrier belonging to one of the plurality of carrier groups.

In the method of the first embodiment, the method may also include determining a hybrid-automatic-repeat-request-acknowledgment codebook size. The method may also include receiving an uplink control signaling from the user equipment.

In the method of the first embodiment, the configuring the user equipment comprises transmitting an indication of the size of each carrier group.

In the method of the first embodiment, the configuring the user equipment comprises transmitting a mapping between configured serving cells and the plurality of carrier groups.

In the method of the first embodiment, the transmitting the plurality of downlink assignments to the user equipment comprises transmitting physical downlink control channel downlink assignments.

In the method of the first embodiment, the physical downlink control channel downlink assignments are conveyed through a Physical Downlink Control Channel (PDCCH) or an Enhanced Physical Downlink Control Channel (EPDCCH).

In the method of the first embodiment, the determining the hybrid-automatic-repeat-request-acknowledgment codebook size comprises determining the size based on at least one of the number of scheduled carrier groups, the number of carriers in each carrier group, a downlink transmission mode, and spatial/time domain bundling.

In the method of the first embodiment, the incrementing the downlink assignment index comprises updating the downlink assignment index based on a frequency-first, time-second manner.

In the method of the first embodiment, the dimensions of the hybrid-automatic-repeat-request-acknowledgment codebook size is determined according to data-associated control signalling.

According to a second embodiment, an apparatus may include at least one processor. The apparatus may also include at least one memory including computer program code. The at least one memory and the computer program code may be configured, with the at least one processor, to cause the apparatus at least to determine a plurality of carrier groups. The apparatus may also be caused to configure a user equipment to use the plurality of carrier groups. The apparatus may also be caused to increment a downlink assignment index from one scheduled carrier group to another. The downlink assignment index is included with each downlink assignment of a plurality of downlink assignments. The apparatus may also be caused to transmit the plurality of downlink assignments to the user equipment. Each of the plurality of downlink assignments schedules a downlink channel on a carrier belonging to one of the plurality of carrier groups.

In the apparatus of the second embodiment, the apparatus is further caused to determine a hybrid-automatic-repeat-request-acknowledgment codebook size. The apparatus is also further caused to receive an uplink control signaling from the user equipment.

In the apparatus of the second embodiment, the configuring the user equipment comprises transmitting an indication of the size of each carrier group.

In the apparatus of the second embodiment, the configuring the user equipment comprises transmitting a mapping between configured serving cells and the plurality of carrier groups.

In the apparatus of the second embodiment, the transmitting the plurality of downlink assignments to the user equipment comprises transmitting physical downlink control channel downlink assignments.

In the apparatus of the second embodiment, the physical downlink control channel downlink assignments are conveyed through a Physical Downlink Control Channel (PDCCH) or an Enhanced Physical Downlink Control Channel (EPDCCH).

In the apparatus of the second embodiment, the determining the hybrid-automatic-repeat-request-acknowledgment codebook size comprises determining the size based on at least one of the number of scheduled carrier groups, the number of carriers in each carrier group, a downlink transmission mode, and spatial/time domain bundling.

In the apparatus of the second embodiment, the incrementing the downlink assignment index comprises updating the downlink assignment index based on a frequency-first, time-second manner.

In the apparatus of the second embodiment, the dimensions of the hybrid-automatic-repeat-request-acknowledgment codebook size is determined according to data-associated control signalling.

According to a third embodiment, a computer program product may be embodied on a non-transitory computer readable medium. The computer program product may be configured to control a processor to perform a method according to the first embodiment.

According to a fourth embodiment, a method may include receiving, by a user equipment, configuration information for a plurality of carrier groups from a network node. The method may also include receiving a plurality of downlink assignments from the network node. Each of the plurality of downlink assignments schedules a downlink channel on a carrier belonging to one of the plurality of carrier groups. The method may also include determining a hybrid-automatic-repeat-request-acknowledgment codebook size. The method may also include determining resources for conveying hybrid-automatic-repeat-request-acknowledgment. The method may also include transmitting hybrid-automatic-repeat-request-acknowledgment.

In the method of the fourth embodiment, the network node comprises an evolved Node B.

In the method of the fourth embodiment, the receiving the configuring information comprises receiving an indication of the size of each carrier group.

In the method of the fourth embodiment, the receiving the configuring information comprises receiving a mapping between configured serving cells and the plurality of carrier groups.

In the method of the fourth embodiment, the receiving the plurality of downlink assignments comprises receiving physical downlink control channel downlink assignments. The downlink assignment index is included with each downlink assignment.

In the method of the fourth embodiment, the physical downlink control channel downlink assignments are conveyed through a Physical Downlink Control Channel (PDCCH) or an Enhanced Physical Downlink Control Channel (EPDCCH).

In the method of the fourth embodiment, the determining the hybrid-automatic-repeat-request-acknowledgment codebook size comprises determining the size based on at least one of the number of scheduled carrier groups and the number of carriers in each carrier group, a downlink transmission mode, and spatial/time domain bundling.

In the method of the fourth embodiment, the method may also include determining the number of scheduled carrier groups based on a downlink assignment index incremented from one scheduled carrier group to another.

In the method of the fourth embodiment, the method may also include determining a number of scheduled carrier groups based on the downlink assignment index on the received downlink assignments.

According to a fifth embodiment, an apparatus may include at least one processor. The apparatus may also include at least one memory including computer program code. The at least one memory and the computer program code may be configured, with the at least one processor, to cause the apparatus at least to receive configuration information for a plurality of carrier groups from a network node. The apparatus may also be caused to receive a plurality of downlink assignments from the network node. Each of the plurality of downlink assignments schedules a downlink channel on a carrier belonging to one of the plurality of carrier groups. The apparatus may also be caused to determine a hybrid-automatic-repeat-request-acknowledgment codebook size. The apparatus may also be caused to determine resources for conveying hybrid-automatic-repeat-request-acknowledgment. The apparatus may also be caused to transmit hybrid-automatic-repeat-request-acknowledgment.

In the apparatus of the fifth embodiment, the network node comprises an evolved Node B.

In the apparatus of the fifth embodiment, the receiving the configuring information comprises receiving an indication of the size of each carrier group.

In the apparatus of the fifth embodiment, the receiving the configuring information comprises receiving a mapping between configured serving cells and the plurality of carrier groups.

In the apparatus of the fifth embodiment, the receiving the plurality of downlink assignments comprises receiving physical downlink control channel downlink assignments, and the downlink assignment index is included with each downlink assignment.

In the apparatus of the fifth embodiment, the physical downlink control channel downlink assignments are conveyed through a Physical Downlink Control Channel (PDCCH) or an Enhanced Physical Downlink Control Channel (EPDCCH).

In the apparatus of the fifth embodiment, the determining the hybrid-automatic-repeat-request-acknowledgment codebook size comprises determining the size based on at least one of the number of scheduled carrier groups and the number of carriers in each carrier group, a downlink transmission mode, and spatial/time domain bundling.

In the apparatus of the fifth embodiment, the apparatus is further caused to determine the number of scheduled carrier groups based on a downlink assignment index incremented from one scheduled carrier group to another.

In the apparatus of the fifth embodiment, the apparatus is further caused to determine a number of scheduled carrier groups based on the downlink assignment index on the received downlink assignments.

According to a sixth embodiment, a computer program product may be embodied on a non-transitory computer readable medium. The computer program product may be configured to control a processor to perform a method according to the fourth embodiment.

### BRIEF DESCRIPTION OF THE DRAWINGS

For proper understanding of the invention, reference should be made to the accompanying drawings, wherein:

FIG. 1 illustrates a maximum number of HARQ-ACK feedback bits per subframe.

FIG. 2 illustrates using a downlink-downlink assignment index (DL-DAI) in time division LTE (LTE Frame Structure 2, TD-LTE).

FIG. 3 illustrates incrementing DAI in accordance with certain embodiments of the present invention.

FIG. 4 illustrates incrementing DAI in accordance with certain embodiments of the invention when performing time domain bundling.

FIG. 5 illustrates a flowchart of a method in accordance with certain embodiments of the invention.

FIG. 6 illustrates a flowchart of another method in accordance with certain embodiments of the invention.

FIG. 7 illustrates an apparatus in accordance with certain embodiments of the invention.

FIG. 8 illustrates an apparatus in accordance with certain embodiments of the invention.

FIG. 9 illustrates an apparatus in accordance with certain embodiments of the invention.

### DETAILED DESCRIPTION

Certain embodiments of the present invention relate to implementing dynamic codebook adaptation for enhancing carrier aggregation. For example, certain embodiments of the present invention may relate to enhancing LTE carrier aggregation to use more than 5 component carriers. These enhancements may be standardized as a part of 3GPP LTE Release 13. These enhancements may be used when transmitting control signals (such as HARQ-ACK) via Physical Uplink Control Channel or Physical Uplink Shared Channel. Certain embodiments of the present invention may be used in conjunction with a Physical Uplink Control Channel (PUCCH).

Specifically, certain embodiments of the present invention may be directed to enhancing Hybrid Automatic Repeat Request-Acknowledgement (HARQ-ACK) feedback in the uplink (UL). Certain embodiments may provide enhancements that facilitate efficient operation of a high number of downlink (DL) component carriers. Certain embodiments of the present invention may be directed to enhancing acknowledgements corresponding to Physical Downlink Shared Channel (PDSCH) transport blocks. Enhancing the acknowledgements may facilitate operations that use a high number of downlink (DL) component carriers.

With respect to HARQ-ACK payload/codebook size, one of the current technical objectives is to specify mechanisms that enable LTE carrier aggregation of up to 32 component carriers for the DL and the UL. One consequence of enabling such carrier aggregation is that the amount of HARQ-ACK feedback will generally increase considerably, as compared to the current situation (where the current situation may be a situation specified by Release 12, for example). With the current situation, the maximum number of UL and DL component carriers may only be 5.

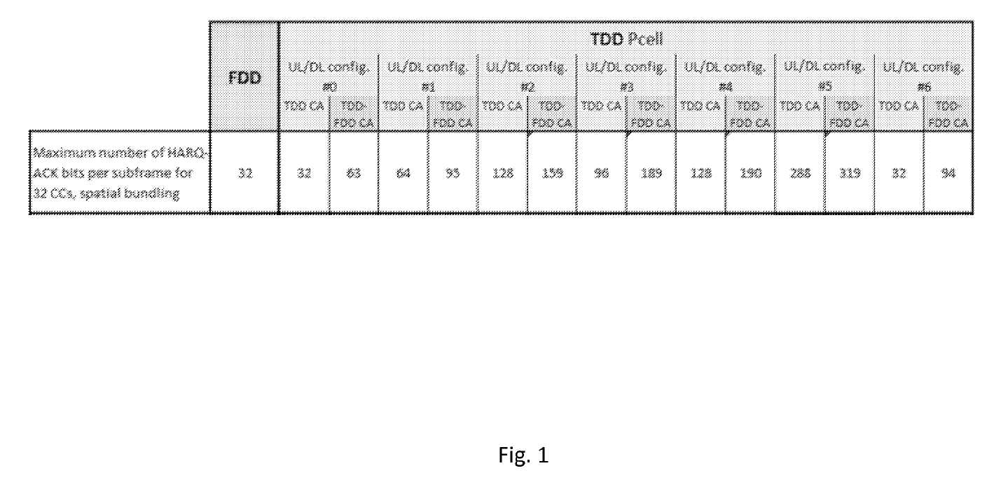

FIG. 1 illustrates an increase in an amount of HARQ-ACK feedback. FIG. 1 illustrates a maximum number of HARQ-ACK feedback bits per subframe for 32-carrier carrier aggregation. 288 bits (9×32) may be needed, assuming that spatial bundling is applied on each carrier. Without spatial bundling, the number would be 576 bits (2×288). The carrier aggregation may be frequency division duplex (FDD), time division duplex (TDD), and/or TDD-FDD CA, for example, where TDD-FDD CA means carrier aggregation where part of the carriers are TDD carriers and part of the carriers are FDD carriers.

With TDD CA, a certain UL/DL configuration may be used for all carriers, for illustration purposes. With TDD-FDD CA, a primary cell (Pcell) and a physical uplink control channel (PUCCH) are assumed to be (on) TDD carriers with a certain UL/DL configuration, while the other carriers may be assumed to be FDD carriers for illustration purposes. Otherwise, part of the aggregated cells apply TDD and part of the cells apply FDD with TDD-FDD CA. Primary cell may be either TDD or FDD cell.

Certain embodiments of the present invention may relate to reducing a number of HARQ-ACK feedback bits that are associated with configured, but non-scheduled, serving cells/subframes. There may be a need to dynamically adapt a codebook size of HARQ-ACK, i.e. the number of HARQ-ACK feedback bits (for example, there may be a need to dynamically adapt a HARQ-ACK payload/codebook size).

Since Release 10, the basic assumption in LTE carrier aggregation is that HARQ-ACK feedback is provided for all the configured carriers, regardless of whether those carriers are actually scheduled, or whether those carriers are even activated. The only exception to this approach of providing HARQ-ACK feedback occurs in the event when a UE receives a DL assignment only for the Pcell. In such an event, the HARQ-ACK feedback is provided for the PCell using only PUCCH format 1a/b.

One drawback of the current approaches is that the UL overhead due to HARQ-ACK signaling is generally a significant amount even if the evolved Node B (eNB) chooses to schedule, for example, only one (SCell) or two cells at a time. Maximizing the UL overhead may not have been a significant drawback until now because the number of supported carriers did not exceed 5 carriers (from the L1 specifications point of view).

As discussed above, in Release 13, the number of scheduled carriers is expected to increase (for example, the scheduled carriers may increase up to 32 scheduled carriers). Utilizing such an increased, larger number of carriers generally results in a large amount of HARQ-ACK overhead. However, the eNB will probably not simultaneously schedule all (or even nearly all) the carriers at the same time. As such, there is a need for enhancing the efficiency of the usage of HARQ-ACK resources.

Certain embodiments of the present invention may dynamically adjust a HARQ-ACK codebook size on a per need basis in order to reduce a physical uplink control channel (PUCCH) overhead. It is expected that a PUCCH format for HARQ-ACK feedback can be dynamically selected with the use of ARI (ACK/NACK resource indicator). The payload size may also be adjusted in order to reduce the uplink control information (UCI) overhead on a physical uplink shared channel (PUSCH).

It may be desirable to configure dynamic HARQ-ACK codebook size adaptation as a part of LTE Release 13 enhancements to carrier aggregation. Certain embodiments of the present invention may provide improved robustness against signaling errors, as described in more detail below. Certain embodiments of the present invention may also minimize certain additional complexity (complexity at both the user equipment (UE) and the eNB sides, for example). Certain embodiments of the present invention may also minimize the need for additional signaling on the DL side. Certain embodiments of the present invention may also dynamically adapt a HARQ-ACK codebook size for both PUSCH and for PUCCH. Certain embodiments of the present invention may support the use of 32 component carriers, for example. Certain embodiments of the present invention may support a wide range of TDD UL-DL configurations. Certain embodiments of the present invention may support efficient PUCCH resource usage. Certain embodiments of the present invention may provide efficient operation in scenarios with a high number of configured carriers and a low number of scheduled carriers. Certain embodiments of the present invention may provide robust operation during radio resource control (RRC) configuration of carrier aggregation features.

With respect to error-case handling, the DL assignments for a single UE may be separately encoded for each component carrier (CC) and subframe. As such, error cases relating to different CCs, as well as to subframes of each CC, may be independent. Failure to receive a DL assignment may be considered to be a discontinuous transmission (DTX) (a discontinuous reception may be, for example, a Discontinuous eNB Transmission per CC and per subframe from the UE's viewpoint).

If the number of HARQ-ACK bits to be transmitted back to the eNB is defined by the number of received DL assignments, when the reception/receiving of DL assignment scheduling a physical downlink shared channel (PDSCH) fails, the ACK/NACK(s) associated with this PDSCH would be missing from the given UL sub-frame. The ACK/NACK(s) would be missing because the UE has missed the DL assignment. Therefore, the UE would have no reason to include an ACK/NACK for the failed/missing DL assignment. As such, as discussed above, with the current carrier aggregation framework, HARQ-ACK is reported for all the carriers, regardless of whether the carriers are scheduled or not. For the carriers for which the UE does not detect a DL assignment, the UE may simply feedback a NACK. There may be no distinguishing between incorrect reception of a PDSCH transport block (NACK) and a DTX.

When dynamically adapting a HARQ-ACK codebook size in view of given performance requirements, an eNB should have a correct understanding about the HARQ-ACK codebook size (for example, the eNB should have a correct understanding about the number of ACK/NACK bits) that the UE assumes for a jointly-coded packet containing HARQ-ACKs for a given set of CCs/subframes. Otherwise, the adaptations may not meet all the error criteria as defined in Technical Specification 36.104.

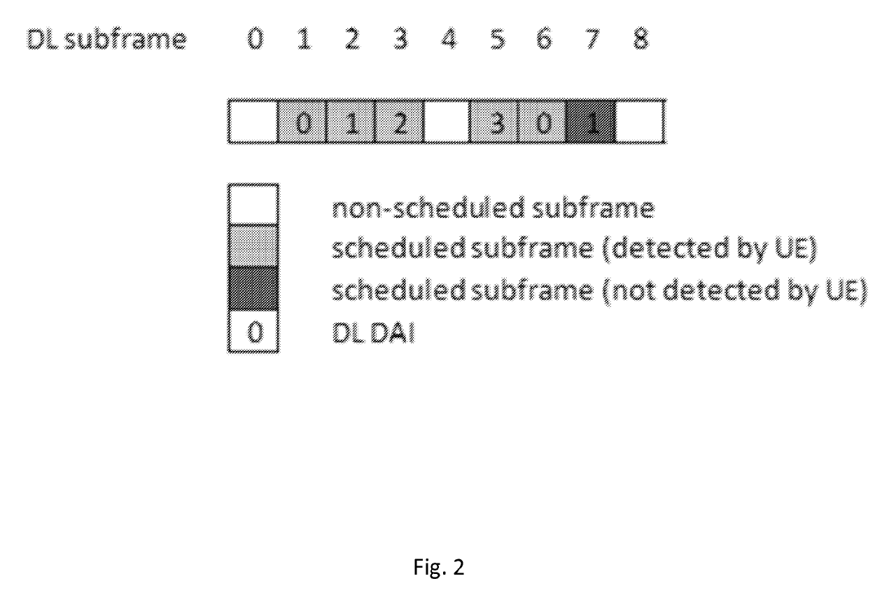

FIG. 2 illustrates using a downlink-downlink assignment index (DL-DAI) in time division LTE (TD-LTE) assuming to have 9 DL subframes available according to TDD uplink-downlink configuration #5. Other approaches that are defined for TD-LTE generally cannot provide dynamic adaptation of HARQ-ACK codebook size for both PUCCH and PUSCH. With the other approaches, dynamic adapting of HARQ-ACK codebook size generally cannot be used because the eNB cannot be guaranteed to have a correct understanding about the number of encoded HARQ-ACK bits. For example, UL-DAI is not available with PUCCH, because PUCCH is generally only used when PUSCH is not transmitted (and thus UL grant is not available). The other approaches defined for DL-DAI are generally not robust enough to handle scenarios with last grant failure(s) potentially occurring on each carrier, in the event of using up to 32 CCs, where joint coding for HARQ-ACK bits is applied without any additional information provided by the UE.

As described above, certain embodiments of the present invention may be directed to dynamic HARQ-ACK codebook adaptation. Certain embodiments of the present invention may include features directed to carrier grouping, features directed to Downlink Assignment Index (DAI) design, features directed to dynamic codebook-size adaptation (based on a number of scheduled Carrier Groups), and/or features directed to handling (E)PDCCH DL assignment failures related to last carrier group(s), for example.

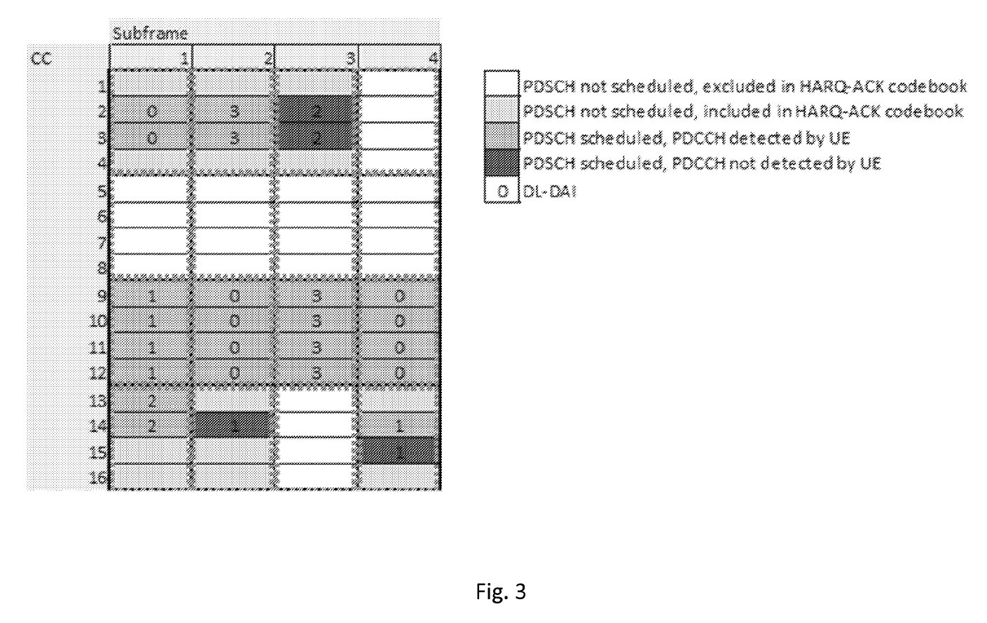

Certain embodiments of the present invention may provide each of the above-described features, as described in more detail below. FIG. 3 illustrates an example of elements of certain embodiments of the present invention. More specifically, FIG. 3 illustrates using a downlink-downlink assignment index (DL-DAI) in time division LTE (TD-LTE) when applying carrier grouping.

With regard to carrier grouping, within a subframe, N component carriers may form a logical Carrier Group. “N” can be a parameter that is configured via higher layers (for example, as a part of Carrier Aggregation (CA) configuration). A carrier grouping can be considered to be a semi-static configuration for a UE. For example, a CC configured to a UE may be associated to a certain Carrier Group.

FIG. 3 illustrates incrementing DAI in accordance with certain embodiments of the present invention. FIG. 3 illustrates an example where 4 carrier groups with N=4 carriers each are configured by higher layers, resulting in a total of 16 configured component carriers. N may also vary from group-to-group.

With regard to DL-DAI design, a carrier group-specific DAI may be applied. The value of DL-DAI may be common to all Enhanced PDCCH and/or PDCCH ((E)PDCCH) DL assignments within one carrier group. DAI may be incremented when moving from one scheduled carrier group to another. DAI may also be incremented in a frequency-first, time/subframe-second manner.

DAI design may have a nested property with respect to Release 12 DL-DAI in the case of a single configured carrier. If only a PCell is scheduled, the DAI operation may be configured to operate in accordance with Release 12 DAI. Such a configuration may provide robustness against errors in determining HARQ-ACK codebook size upon Radio Resource Control (RRC) configuration of a carrier aggregation feature. Due to time ambiguity, the eNB may choose to schedule only the PCell until the eNB is certain that the UE has been correctly configured with additional carriers.

With regard to dynamic codebook adaptation, a codebook size can be dynamically adapted. Each carrier group with at least one (E)PDCCH DL assignment (i.e., each carrier group with a scheduled PDSCH) may increase the HARQ-ACK codebook size by a fixed amount. The amount of increase may correspond to the carrier group size of that specific carrier group. For example, the amount of increase may be N bits. This assumes that spatial bundling is applied. If spatial bundling is not applied, then the DL transmission mode (TM) configured in different cells of the Carrier Group supporting LTE single user spatial multiplexing (requiring two HARQ-Ack bits per subframe per cell and UE) or only do support single user spatial multiplexing (requiring only 1 HARQ-Ack bit per subframe per cell and UE) will define the HARQ-ACK payload/codebook size of different Carrier Groups. The codebook size can also be incremented when the UE identifies that PDCCH DL assignments (related to one or more Carrier Groups) were not received at all. The codebook size can be incremented in accordance with the knowledge/rule of having an increasing DL-DAI from one Carrier Group having a DL assignment to the next carrier group.

In the example illustrated by FIG. 3, there may be 10 scheduled carrier groups and 6 non-scheduled carrier groups within the example of 4 subframes within the HARQ-ACK bundling window, with an equal carrier group size of N=4. Assuming that spatial HARQ-ACK bundling is applied, the number of HARQ-ACK bits corresponds to 10×N bits=40 bits.

HARQ-ACK bits that correspond to scheduled carrier groups/subframes may be aggregated in the HARQ-ACK codebook in a predefined order (for example, bits relating to frequency first, and bits relating to time second).

With regard to failure of reception of PDCCH(s) DL assignments corresponding to last scheduled carrier group(s), the UE is able to correctly determine the overall number of carrier groups with DL assignments (in the example illustrated by FIG. 3). The UE is therefore able to correctly adjust the HARQ-ACK codebook size and is able to report the HARQ-ACK in the correct order (positions). The UE is able to perform the above adjusting and reporting as long as at least one PDCCH DL assignment is correctly received by the UE within the last scheduled carrier group. This case is illustrated by the example illustrated by FIG. 3.

However, the UE cannot determine if one or more of the last scheduled carrier groups are completely missed by the end of the HARQ-ACK aggregation window. Not being able to determine if one or more of the last scheduled carrier groups are missed may lead to an incorrect HARQ-ACK codebook size determination by the UE. Therefore, there may potentially be a failed decoding of the HARQ-ACK information at the eNB.

There are a few options available to address the problem of missing last scheduled carrier groups of the last subframe within the HARQ-ACK bundling window. One option may be an eNB-implementation based approach where the eNB schedules multiple PDSCHs (for the last carrier group) to reduce the probability that all DL grants corresponding to the last carrier group are missed. Another option may be an eNB-implementation based approach that uses a higher aggregation level for the DCIs (carrying the DL assignment(s) for the last scheduled carrier group) to decrease the probability of missed detection of specifically the last scheduled carrier group within the scheduling window. Another option may be an eNB implementation by a combination of the two above-described options (higher Enhanced PDCCH or PDCCH aggregation level combined with several scheduled carriers). Other options may be standardization-based options, as described in more detail below.

With regard to time domain bundling, time domain bundling can be configured and applied on top of certain embodiments of the present invention, as described in more detail below.

Certain embodiments of the present invention may dynamically adapt a HARQ-ACK codebook for both of the following cases: (1) HARQ-ACK transmitted on PUCCH, and (2) HARQ-ACK transmitted on PUSCH. With certain embodiments, dynamic HARQ-ACK codebook size adjustment may be combined with ACK/NACK resource index (ARI) signalling. One set of codepoints of ARI (e.g., ‘00’ and ‘01’) are reserved for PUCCH with a smaller payload (such as a PUCCH Format 3, for example). The set of codepoints may be applied in the cases when a small number of carrier groups are scheduled.

Another set of codepoints of ARI (such as, for example, ‘10’ and ‘11’) may be reserved for PUCCH with a larger payload (such as a larger PUCCH Format supporting, for example, up to 100 bits, denoted with PUCCH Format 4). These codepoints are applied in the cases when a large number of carrier groups are scheduled. The number of ARI bits in the DL grant can also be more than 2. The number of available PUCCH formats can also be more than 2. Different PUCCH formats may also involve different coding schemes. For example, Format 3 may utilize block coding (such as dual Reed Muller) and Format 4 may utilize convolutional coding.

There are some standardized solutions for handling failure to correctly decode DCIs that carry the DL assignment of the last Carrier Group(s). A first option may use data-associated control signalling (where the signalling is signalled via UL). With this first option, a UE determines the dimensions of a HARQ-ACK codebook according to transmitted data-associated control signalling. This signalling could indicate, for example, a DL-DAI that corresponds to the last Carrier Group that the UE was able to detect. This signalling can be conveyed, for example, as part of demodulation reference signal sequences (e.g., cyclic shift selection, orthogonal cover code).

A second option for handling failure to correctly decode DCIs may use additional signalling in DL. This second option may introduce additional (implicit or explicit) signalling into a DL grant in order to indicate to the UE that this is the last CC group scheduled by the eNB. If the UE receives this signalling, then the UE can be assured that such an error case is not there. If the UE does not receive this signalling, then the UE could add NACKs for one additional subframe group. Adding NACKs for one additional subframe group may be sufficient because it is generally unlikely that more than one consecutive CC groups are lost.

A third option may use certain combination of ARI and/or DAI bits to indicate the last scheduled Carrier Group. For example, the ARI bits of the second and/or third last Carrier Group could indicate the DAI value of the last scheduled Carrier Group.

A fourth option may define the last carrier group as containing more CCs than the other carrier groups. This would reduce the probability that all DL grants (corresponding to last carrier group) are lost.

A fifth option may use ARI bits to define the DAI of a last scheduled carrier group. Each ARI value may be connected to a predefined DAI value. In accordance with this approach, eNB may select ARI according to the DAI that is assumed for the last scheduled carrier group that defines the HARQ-ACK codebook size. If the number of scheduled carrier groups does not match the selected DAI value, this mismatch would indicate that the end of a HARQ-ACK message may need to be padded with excessive unnecessary NACKs. For example, in the event that N=4 and an actual last DAI equals to “2” but, if ARI would indicate that last DAI is “3”, then 4 additional NACKs may be added. The maximum codebook size can be limited to N×Number of Carrier groups.

A sixth option may be to use DAI of UL assignments to indicate a last carrier group. In the event of scheduling PUSCH for that UE, the DAI bits in UL grant could indicate the DAI of the last Carrier Group that is scheduled. Such an indication may increase the ‘DAI’ diversity for the last scheduled DL carrier group by each PUSCH scheduled carrier.

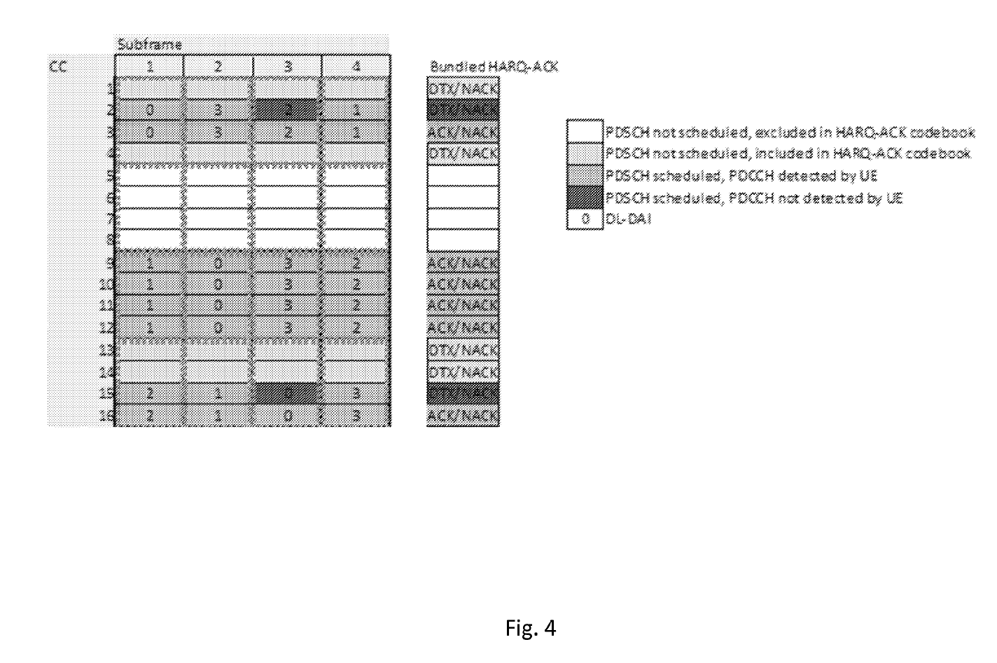

FIG. 4 illustrates performing time domain bundling. With regard to time domain bundling, the below figure illustrates the principle of time domain bundling applied on top of a dynamic HARQ-ACK codebook adaptation. Time domain bundling corresponds to a logical-AND operation for HARQ-ACK corresponding to different subframes of certain CC. This example assumes that time domain bundling is applied for the entire bundling window of a CC (for example, for M subframes). It may be possible to define it for certain subframes only, for example, separately for subframes #1 and #2 and subframes #3 and #4, respectively. In one embodiment, the time domain bundling (if applied, and over how many subframes) is configured by higher layers in a semi-static manner. In the event that certain PDSCH is lost within a time domain bundling window, the entire time domain bundling window is lost.

Certain embodiments of the present invention may facilitate dynamic HARQ-ACK codebook adaptation, which can be applied in both TDD and FDD. With certain embodiments of the present invention, the robustness against (E)PDCCH DL assignment failure may be improved as compared to the case without carrier grouping (through the DAI diversity in case of several scheduled DL carriers). With certain embodiments of the present invention, the cyclic increase in the DAI value across subframe borders additionally increases the probability of failed DL assignment detection and correspondingly reduces the chances of erroneous HARQ-ACK codebook determination (except for the last scheduled carrier group). Certain embodiments of the present invention may provide additional failure detection mechanisms for the last carrier group.

Certain embodiments of the present invention may be compatible with the current DAI/ARI framework. Certain embodiments of the present invention do not require predictive scheduler operation (i.e. the one where eNB knows the number of scheduled subframes before actual scheduling). Certain embodiments of the present invention may be applied for both HARQ-ACK carried on PUCCH and HARQ-ACK carried on PUSCH. Certain embodiments may facilitate efficient uplink control information (UCI) resource usage. Certain embodiments may also support time domain bundling. Certain embodiments may support various eNB scheduler strategies. Certain embodiments may have a specific nested property by including the current TDD DAI operation as a special case when only PCell is scheduled. This property provides inherent robustness during, for example, CC configuration or CC reconfiguration.

In an example embodiment, eNB may receive uplink control signaling (on PUCCH or PUSCH) from the user equipment. The eNB may determine the HARQ-ACK codebook size based on at least in part on the number of scheduled carrier groups, and the number of carriers in each scheduled carrier group, and potential the ARI. In case of TDD, it includes all the subframes within the scheduling window, eNB may determine the HARQ-ACK information based on the received uplink control signaling and the determined HARQ-ACK codebook size.

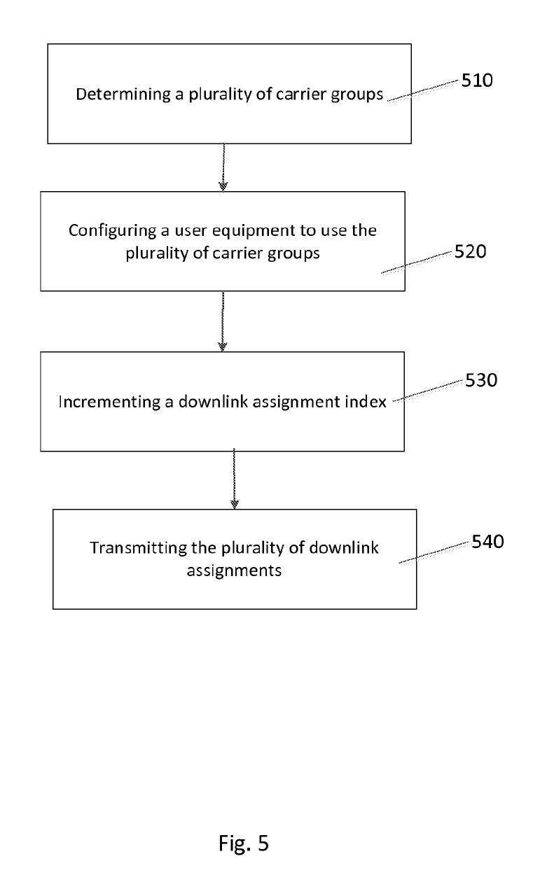

FIG. 5 illustrates a flowchart of a method in accordance with certain embodiments of the invention. The method illustrated in FIG. 5 includes, at 510, determining, by a network node, a plurality of carrier groups. The method may also include, at 520, configuring a user equipment to use the plurality of carrier groups. The method may also include, at 530, incrementing a downlink assignment index from one scheduled carrier group to another. The downlink assignment index is included with each downlink assignment of a plurality of downlink assignments. The method may also include, at 540, transmitting the plurality of downlink assignments to the user equipment. Each of the plurality of downlink assignments schedules a downlink channel on a carrier belonging to one of the plurality of carrier groups.

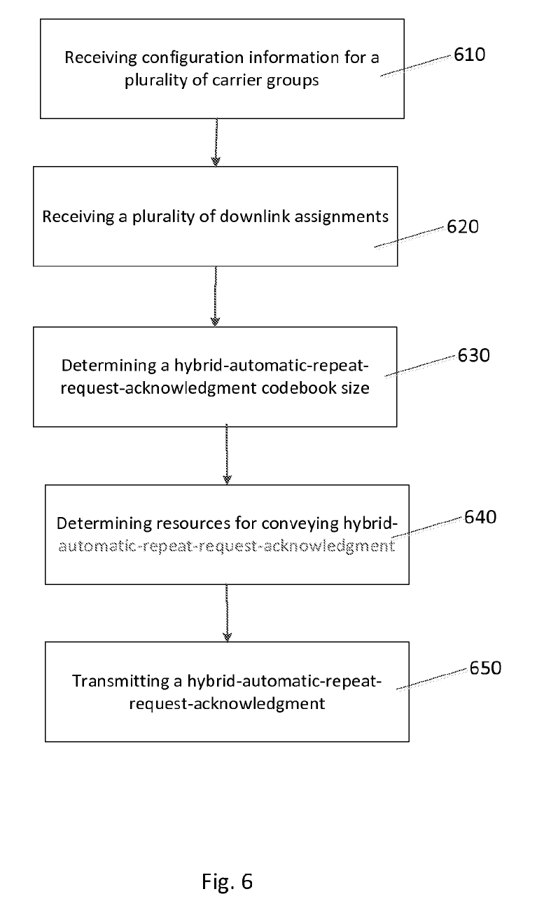

FIG. 6 illustrates a flowchart of a method in accordance with certain embodiments of the invention. The method illustrated in FIG. 6 includes, at 610, receiving, by a user equipment, configuration information for a plurality of carrier groups from a network node. The method also includes, at 620, receiving a plurality of downlink assignments from the network node. Each of the plurality of downlink assignments schedules a downlink channel on a carrier belonging to one of the plurality of carrier groups. The method may also include, at 630, determining a hybrid-automatic-repeat-request-acknowledgment codebook size. The method may also include, at 640, determining resources for conveying hybrid-automatic-repeat-request-acknowledgment. The method may also include, at 650, transmitting hybrid-automatic-repeat-request-acknowledgment.

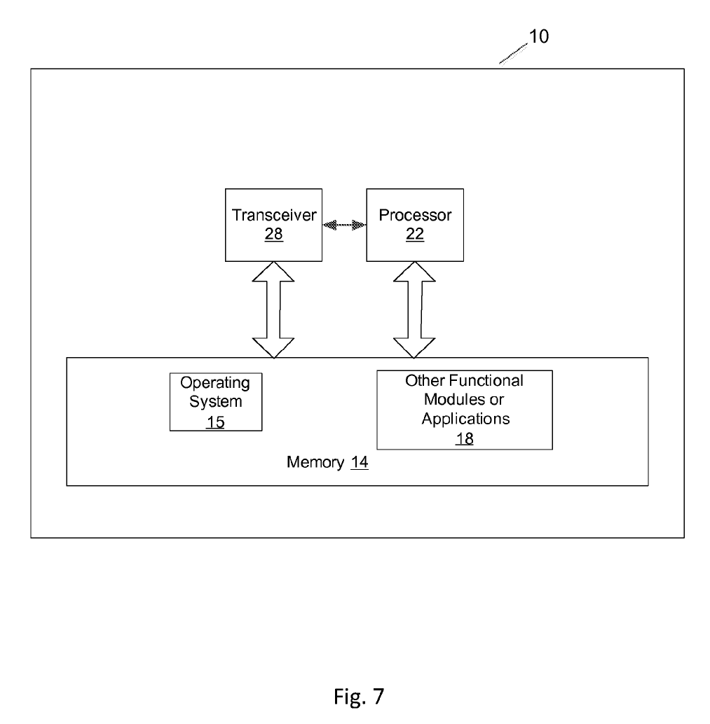

FIG. 7 illustrates an apparatus in accordance with certain embodiments of the invention. In one embodiment, the apparatus can be a user equipment, a base station, and/or an eNB, for example. The apparatus can be a network node. Apparatus 10 can include a processor 22 for processing information and executing instructions or operations. Processor 22 can be any type of general or specific purpose processor. While a single processor 22 is shown in FIG. 7, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources. Apparatus 10 can thus be configured to perform the methods of FIGS. 5 and 6, as described above.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

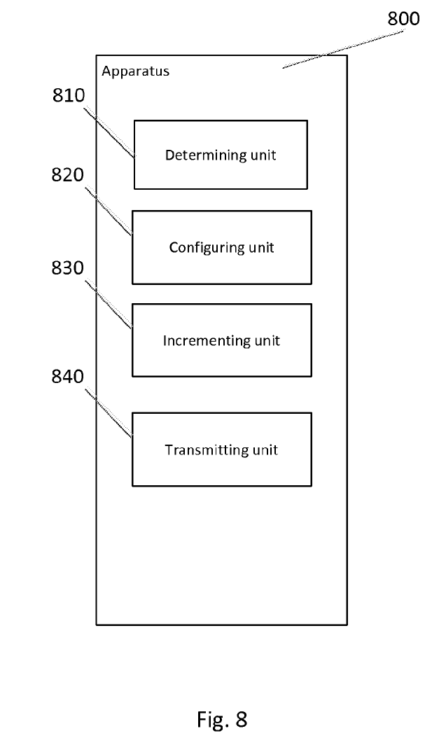

FIG. 8 illustrates an apparatus in accordance with certain embodiments of the invention. Apparatus 800 can be a network element/entity such as a base station and/or evolved Node B, for example. Apparatus 800 can include a determining unit 810 that determines a plurality of carrier groups. Apparatus 800 may also include a configuring unit 820 that configures a user equipment to use the plurality of carrier groups. Apparatus 800 may also include an incrementing unit 830 that increments a downlink assignment index from one scheduled carrier group to another. The downlink assignment index is included with each downlink assignment of a plurality of downlink assignments. Apparatus 800 may also include a transmitting unit 840 that transmits the plurality of downlink assignments to the user equipment. Each of the plurality of downlink assignments schedules a downlink channel on a carrier belonging to one of the plurality of carrier groups.

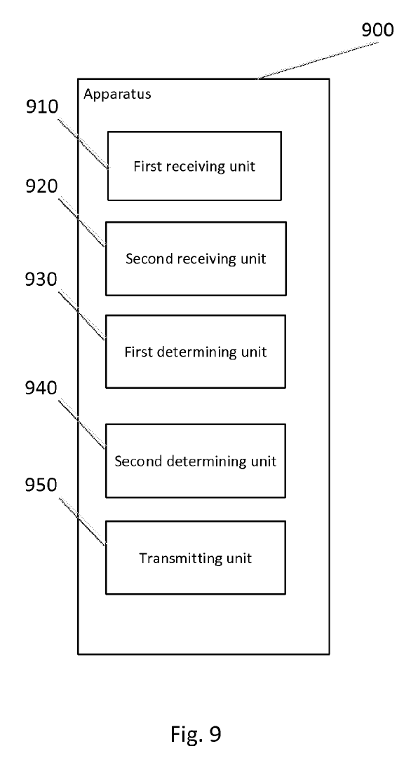

FIG. 9 illustrates an apparatus in accordance with certain embodiments of the invention. Apparatus 900 can be a user equipment, for example. Apparatus 900 can include a first receiving unit 910 that receives configuration information for a plurality of carrier groups from a network node. Apparatus 900 can also include a second receiving unit 920 that receives a plurality of downlink assignments from the network node. Each of the plurality of downlink assignments schedules a downlink channel on a carrier belonging to one of the plurality of carrier groups. Apparatus 900 can also include a first determining unit 930 that determines a hybrid-automatic-repeat-request-acknowledgment codebook size. Apparatus 900 can also include a second determining unit 940 that determines resources for conveying hybrid-automatic-repeat-request-acknowledgment. Apparatus 900 can also include a transmitting unit 950 that transmits hybrid-automatic-repeat-request-acknowledgment.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-30. (canceled)

31. A method, comprising:
receiving, by a user equipment, configuration information for a plurality of carrier groups from a network node;
receiving a plurality of downlink assignments from the network node, wherein each of the plurality of downlink assignments schedules a downlink channel on a carrier belonging to one of the plurality of carrier groups; and
determining a hybrid-automatic-repeat-request-acknowledgment codebook size;
determining resources for conveying hybrid-automatic-repeat-request-acknowledgment; and
transmitting hybrid-automatic-repeat-request-acknowledgment.

32. The method according to claim 31, wherein the receiving the configuring information comprises receiving an indication of the size of each carrier group and/or receiving a mapping between configured serving cells and the plurality of carrier groups.

33. The method according to claim 31, wherein the receiving the plurality of downlink assignments comprises receiving physical downlink control channel downlink assignments, and the downlink assignment index is included with each downlink assignment.

34. The method according to claim 31, wherein the determining the hybrid-automatic-repeat-request-acknowledgment codebook size comprises determining the size based on at least one of the number of scheduled carrier groups and the number of carriers in each carrier group, a downlink transmission mode, and spatial/time domain bundling.

35. The method according to claim 34, comprising determining the number of scheduled carrier groups based on a downlink assignment index incremented from one scheduled carrier group to another.

36. The method according to claim 31, further comprising:
receiving a last scheduled carrier group indication, wherein the last scheduled carrier group indication is included with at least one of the plurality of downlink assignments.

37. An apparatus, comprising:
at least one processor; and
at least one memory including computer program code,
the at least one memory and the computer program code configured, with the at least one processor, to cause the apparatus at least to
determine a plurality of carrier groups;
configure a user equipment to use the plurality of carrier groups;
increment a downlink assignment index from one scheduled carrier group to another, wherein the downlink assignment index is included with each downlink assignment of a plurality of downlink assignments; and
transmit the plurality of downlink assignments to the user equipment, wherein each of the plurality of downlink assignments schedules a downlink channel on a carrier belonging to one of the plurality of carrier groups.

38. The apparatus according to claim 37, wherein the apparatus is further caused to:
determine a hybrid-automatic-repeat-request-acknowledgment codebook size; and
receive an uplink control signaling from the user equipment.

39. The apparatus according to claim 37, wherein the configuring the user equipment comprises transmitting an indication of the size of each carrier group and/or transmitting a mapping between configured serving cells and the plurality of carrier groups.

40. The apparatus according to claim 37, wherein the transmitting the plurality of downlink assignments to the user equipment comprises transmitting physical downlink control channel downlink assignments.

41. The apparatus according to claim 40, wherein the physical downlink control channel downlink assignments are conveyed through a Physical Downlink Control Channel (PDCCH) or an Enhanced Physical Downlink Control Channel (EPDCCH).

42. The apparatus according to claim 37, wherein the incrementing the downlink assignment index comprises updating the downlink assignment index based on a frequency-first, time-second manner.

43. The apparatus according to claim 37, wherein the apparatus is further caused to: transmit a last scheduled carrier group indication to the user equipment, wherein the last scheduled carrier group indication is included with at least one of the plurality of downlink assignments.

44. An apparatus, comprising:
at least one processor; and
at least one memory including computer program code,
the at least one memory and the computer program code configured, with the at least one processor, to cause the apparatus at least to
receive configuration information for a plurality of carrier groups from a network node;
receive a plurality of downlink assignments from the network node, wherein each of the plurality of downlink assignments schedules a downlink channel on a carrier belonging to one of the plurality of carrier groups; and
determine a hybrid-automatic-repeat-request-acknowledgment codebook size;
determine resources for conveying hybrid-automatic-repeat-request-acknowledgment; and
transmit hybrid-automatic-repeat-request-acknowledgment.

45. The apparatus according to claim 44, wherein the receiving the configuring information comprises receiving an indication of the size of each carrier group and/or receiving a mapping between configured serving cells and the plurality of carrier groups.

46. The apparatus according to claim 44, wherein the receiving the plurality of downlink assignments comprises receiving physical downlink control channel downlink assignments, and the downlink assignment index is included with each downlink assignment.

47. The apparatus according to claim 44, wherein the determining the hybrid-automatic-repeat-request-acknowledgment codebook size comprises determining the size based on at least one of the number of scheduled carrier groups and the number of carriers in each carrier group, a downlink transmission mode, and spatial/time domain bundling.

48. The apparatus according to claim 47, wherein the apparatus is further caused to determine the number of scheduled carrier groups based on a downlink assignment index incremented from one scheduled carrier group to another.

49. The apparatus according to claim 44, wherein the apparatus is further caused to receive a last scheduled carrier group indication, wherein the last scheduled carrier group indication is included with at least one of the plurality of downlink assignments.

50. The apparatus according to claim 44, wherein the apparatus comprises a user equipment.
